(19) United States
(12) Patent Application Publication
(10) Pub. No.: US 2011/0203118 A1
(43) Pub. Date: Aug. 25, 2011

(54) BRUSH CUTTER

(75) Inventor: Takeshi Saito, Tokyo (JP)

(73) Assignee: Kyodo Co., Ltd.

(21) Appl. No.: 12/708,826

(22) Filed: Feb. 19, 2010

(51) Int. Cl. A01D 34/68

(52) U.S. Cl. 30/276

(57) ABSTRACT

The conventional brush cutter has many drawbacks, such as the large vibration and noise of the main pipe, because the rotary drive shaft is passed through the main pipe. The brush cutter of the present invention has a main pipe, a flat motor provided on a tip end of the main pipe, a rotary cutter provided on a rotary shaft of the flat motor, and a battery provided on a base end of the main pipe for driving the motor.

### BACKGROUND OF THE INVENTION

1. Field of the Invention

The present invention relates to a brush cutter, more particularly relates to a brush cutter for cutting grass and trees by a rotary blade.

2. Description of the Related Art

FIG. 1, shows a conventional brush cutter, wherein reference numeral 1 denotes a main pipe of a brush cutter, 2 denotes an engine provided on the base portion of the main pipe 1, 3 denotes a handle provided on the rear end portion of the main pipe 1, 4 denotes a rotary drive shaft extending through the main pipe 1, 5 denotes a rotary blade provided detachably on the tip end portion of the rotary drive shaft 4, 6 denotes a shoulder band, and 7 denotes a safety cover of the rotary blade 5.

In the conventional brush cutter, a heavy weight engine 2 is provided on the base portion of the main pipe 1 and the rotation of the engine 2 is transmitted through the rotary drive shaft 4 to the rotary blade 5 provided on the tip end portion of the rotary drive shaft 4 in order to rotate the rotary blade 5.

Such conventional brush cutter is disclosed in the Japanese Patent Application Laid-Open No. 2001-120029, for example.

However, such conventional brush cutter has many drawbacks, such as the vibration and noise of the main pipe are large, because the rotary drive shaft 4 is passed through the main pipe 1.

### SUMMARY OF THE INVENTION

Accordingly, an object of the present invention is to obviate such defects.

Another object of the present invention is to provide a brush cutter comprising a main pipe, a flat motor provided on a tip end of the main pipe, a rotary blade provided on a rotary shaft of the flat motor, and a battery provided on a base end of the main pipe for driving the motor.

The flat motor comprises a housing for supporting rotatably the rotary shaft, a rotor fixed to the rotary shaft, a magnet provided on the rotor, a planar stator having a wiring of electric circuit fixed to the housing, a main pipe mount portion provided on the housing, and a holding portion for holding selectively the rotary cutter to the rotary shaft.

A further object of the present invention is to provide a brush cutter further comprising a handle having a grip provided with a power switch for starting and stopping the motor, and a control switch for controlling the revolution number of the motor, the handle being provided on the main pipe, and the control switch being arranged in the vicinity of the power switch.

The control switch is of roller type to be operated by a forefinger of hand which grasps the grip.

A further object of the present invention is to provide a brush cutter further comprising a high speed rotation instruction switch for fixing the revolution number of the motor to a maximum value arranged in the vicinity of the power switch.

The high speed rotation instruction switch is of rotary type operated by a thumb of hand which grasps the grip.

Yet further object of the present invention is to provide a brush cutter comprising a dynamic brake circuit connected to the power switch for breaking the rotation of the motor when the motor is stopped.

The power of the flat motor is about 250 W-800 W.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a perspective view of a conventional brush cutter.

FIG. 2 is perspective view of a brush cutter according to the present invention.

FIG. 3 is a vertical sectional side view of a flat motor for the brush cutter according to the present invention.

FIG. 4 is a perspective view of the flat motor.

FIG. 5 is a side view of a grip of the brush cutter according to the present invention.

FIG. 6 is a plan view of the grip of the brush cutter according to the present invention.

FIG. 7 is a block diagram of an electric control system of the brush cutter according to the present invention.

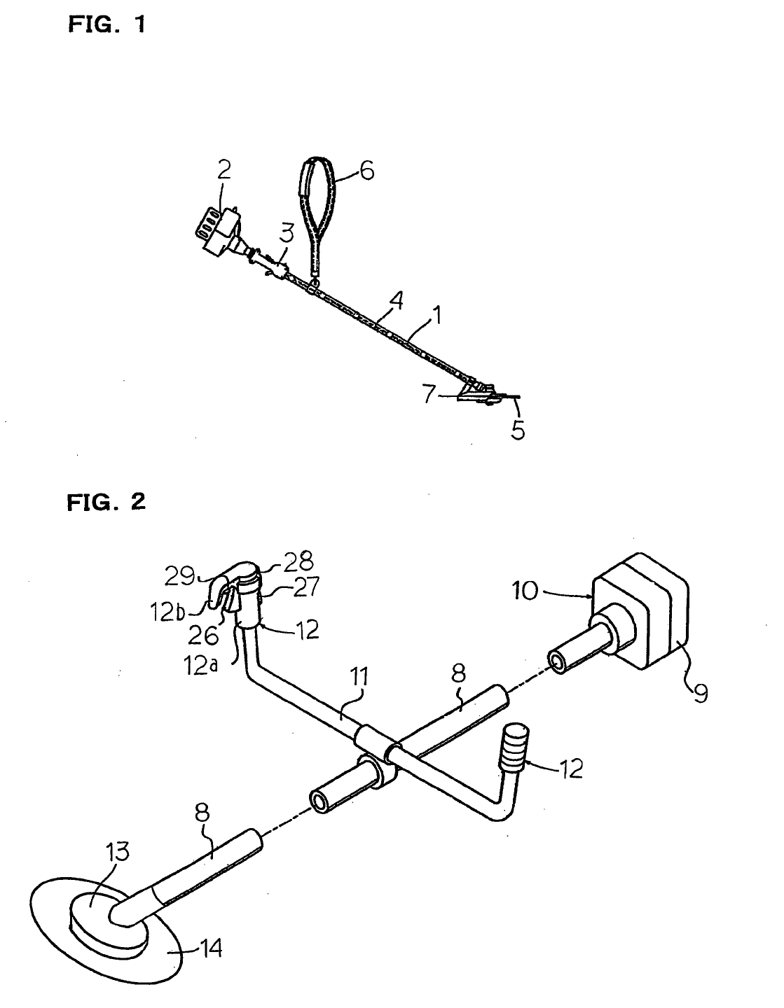

### DESCRIPTION OF THE PREFERRED EMBODIMENTS

A brush cutter of a first embodiment according to the present invention will be explained with reference to the drawings.

The brush cutter of the present invention comprises as shown in FIG. 2, a main pipe 8, a battery 9, such as a lithium battery or a nickel-hydrogen battery and a convertor 10 provided on a base end of the main pipe 8, a handle 11 provided on the center portion of the main pipe 8 across the main pipe 8, grips 12 provided on both ends of the handle 11, a flat motor 13 provided on a tip end of the main pipe 8, and a rotary blade 14 provided on a rotary shaft of the flat motor 13.

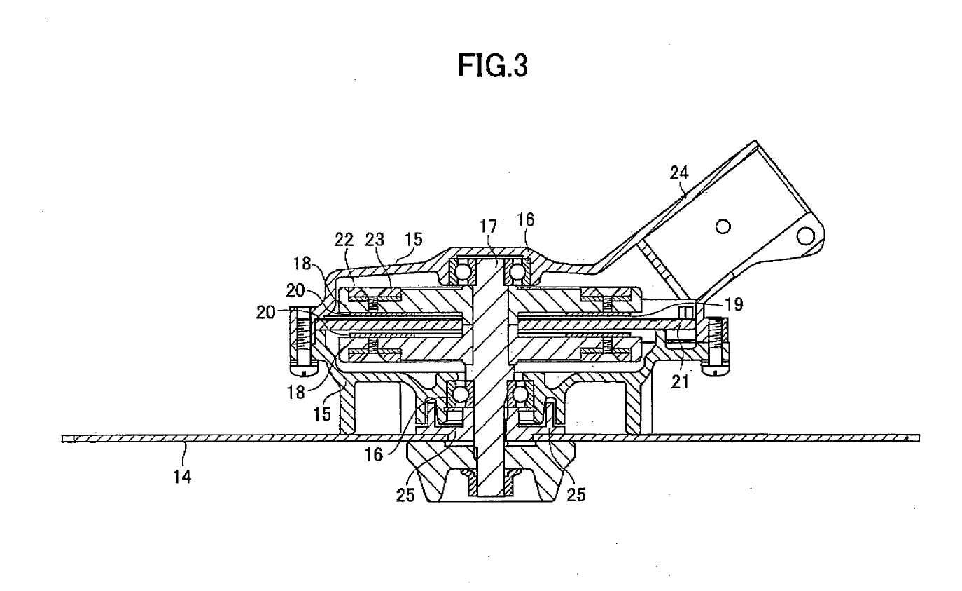

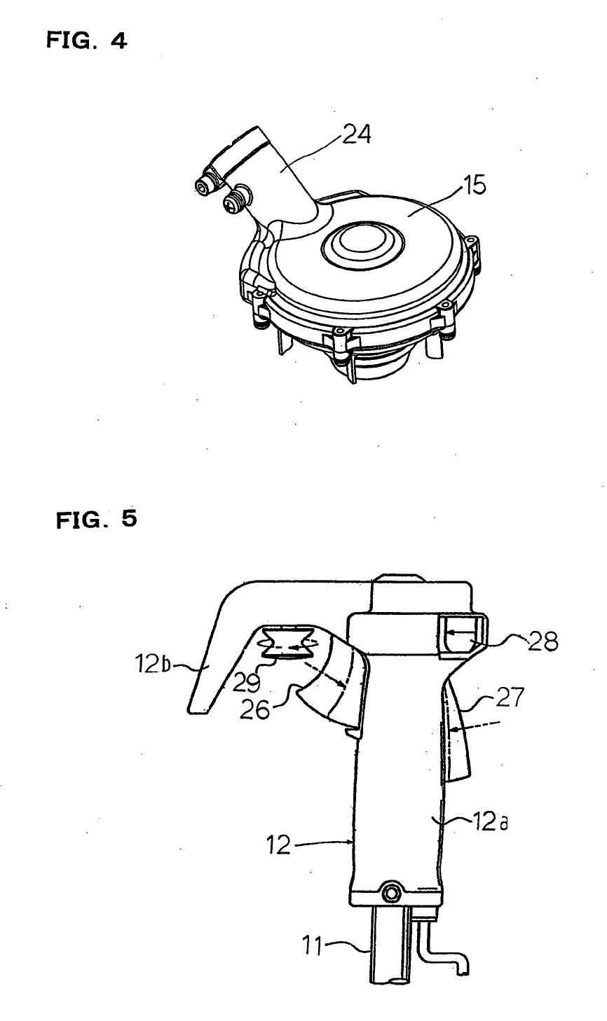

The flat motor 13 comprises as shown in shown in FIG. 3 and FIG. 4 a hollow cylindrical housing 15, a rotary shaft 17 supported rotatably in the housing 15 through a bearing 16, two planar rotors 18 fixed to the rotary shaft 17 so as to face with each other, an annular gap 19 formed between the two planar rotors 18, magnets 20 provided on the surfaces of the rotors 18 facing to each other in the gap 19, a planar stator 21 fixed to the housing 15 so as to be positioned in the gap 19, an electric circuit formed by etching or printing on a copper plate provided on the stator 21, concave portions 22, each provided on the outside surface of each rotor 18, yokes 23 each provided in each concave portion 22 as a flywheel, a main pipe mount portion 24 provided on the outer surface of the housing 15, a holding portion 25 provided on the tip end of the rotary shaft 17 for holding selectively the rotary blade 14 to the rotary shaft 17.

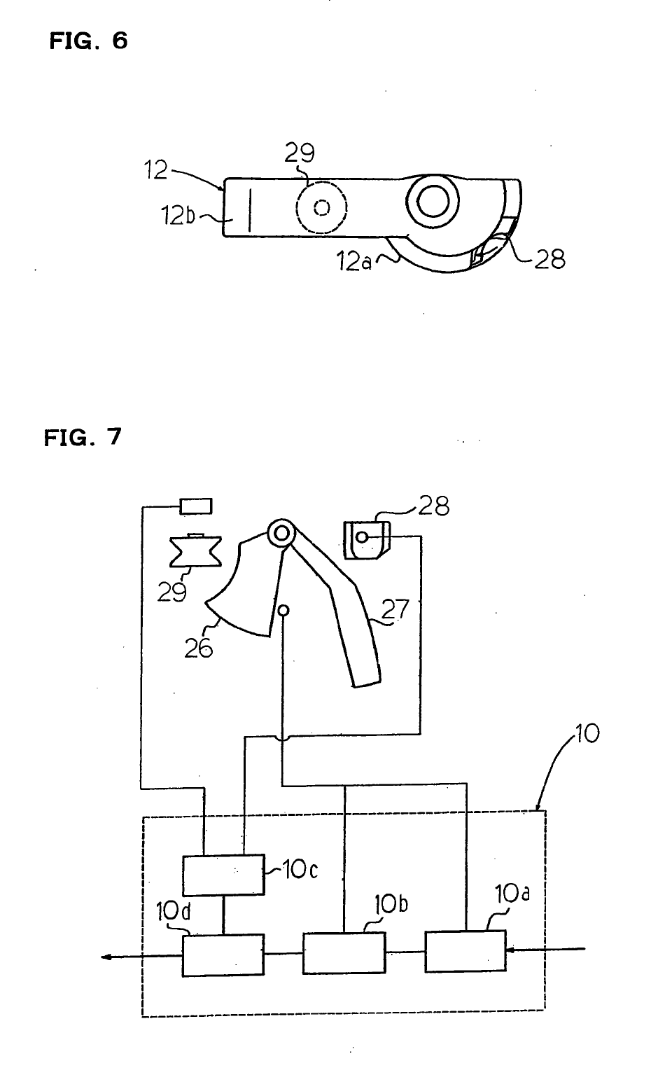

As shown in FIG. 5 and FIG. 6, the grip 12 is formed of a cylindrical body 12a and a protection 12b. The protection 12b is formed of a first portion extending horizontally, radially from an upper end of the cylindrical body 12a and a second portion extending obliquely downwards from the free end of the first portion. An electric power switch 26 is provided on a front side of the cylindrical body 12a. A safety switch 27 is provided on a back side of the cylindrical body 12a. A high speed rotation instruction switch 28 is provided on the upper end of the cylindrical body 12a. A rotation control switch 29 is provided on a lower side of the first portion of the protection 12b. The cylindrical body 12a of the grip 12 is formed of the size and shape so as to be grasped easily by hand to control the angle and the swing of the rotary blade 14 through the handle 11. The protection 12b prevents the hand form being damaged and injured due to the collision with the grass or trees. Further, unexpected operation and damage of the electric power switch 26 or the rotation control switch 29 due to the collision with the grass or trees can be prevented.

The electric power switch 26 is formed of rotary type, and operated against a spring (not shown) by a finger of hand grasping the cylindrical body 12a of the grip 12 so as to start the rotation of the flat motor 13 and to stop the rotation of the flat motor 13 when the finger is loosened by the spring. As shown in FIG. 7, the electric power switch 26 is connected to a drive stop circuit 10a and a dynamic brake circuit 10b. The drive stop circuit 10a is effected so as to turn ON or OFF the flat motor 13. When the electric power switch 26 is changed so as to stop the rotation of the flat motor 13, the dynamic brake circuit 10b is effected so that the flat motor 13 is operated as a dynamo and that resistors etc. connected between terminals of the flat motor 13 are short circuited so as to consume the rotation energy of the flat motor 13 as heat.

The safety switch 27 is formed of rotary type and connected to the electric power switch 26 through a mechanical linkage etc. (not shown). The electric power switch 26 is turned ON against a spring (not shown) when the cylindrical body 12a of the grip 12 is gripped tightly by hand, and turned OFF when the grip is loosened.

The high speed rotation instruction switch 28 is formed of rotary type and operated against a spring (not shown) by a thumb of the hand which grasps the cylindrical body 12a of the grip 12 so as to fix the revolution number of the flat motor 13 to the maximum value. The high speed rotation instruction switch 28 is connected to a primary rotation control circuit 10c of the convertor 10. The primary rotation control circuit 10c is connected to a secondary rotation control circuit 10d of the convertor 10 which varies the revolution number of the flat motor 13 by the voltage adjustment. The instruction for the rotary number of the flat motor 13 from the rotation control switch 29 is cleared when an instruction for fixing the revolution number of the flat motor 13 to the maximum value is generated from the high speed rotation instruction switch 28.

The rotation control switch 29 is formed of rotary type and operated by a forefinger of hand which grasps the cylindrical body 12a of the grip 12 so as to adjust the revolution number of the flat motor 13. The rotation control switch 29 is connected to the primary rotation control circuit 10c of the convertor 10.

In the brush cutter according to the present invention, the flat motor 13 can be positioned on the tip end of the main pipe 8, because the flat motor 13 has no windings so that the flat motor 13 is light in weight. Accordingly, it is not necessary to extend the rotary shaft 17 passing through the main pipe 8, so that the vibration and the noise of the main pipe 8 can be reduced.

Further, the power lose of the brush cutter according to the present invention can be reduced, because the flat motor 13 having no winding is provided on the tip end of the main pipe 8.

Further, the present invention, the brush cutter is light in weight and can be operated long time, because the lithium battery or the nickel-hydrogen battery is used as the battery 9.

Further, the rotation of the rotary blade 14 can be stabilized, because the function of flywheel is added to the flat motor 13.

Further, the revolution number of the flat motor 13 can be controlled precisely, because the rotation control switch 29 which is provided in the vicinity of the electric power switch 26 can be operated by the finger of hand gripping the cylindrical body 21a of the grip 12 provided on the handle 11 for controlling the angle and the swing of the rotary blade 14, without adjusting the gripping force applying to the cylindrical body 12a of the grip 12. Especially, the fine control of the revolution number of the flat motor 13 can be carried out without reducing the operability of the handle 11 for controlling the angle and the swing of the rotary blade 14, because the rotation control switch 29 of roller type which can be operated by a small force is operated by the forefinger of hand without reducing the gripping fore applied to the cylindrical body 12a of the grip 12. As a result, an effective cutting operation can be carried out corresponding to the thickness and hardness of the grass or trees, and the consumption of energy in the battery used as an electric power source can be reduced.

Further, it is possible to cut the grass and trees even in case that the thin and soft grass and the thick and hard trees are mixed, because the revolution number of the flat motor 13 can maximize quickly by the operation of the high speed rotation instruction switch 28. In this case, priority of operation is given to the high speed rotation instruction switch 28, so that there is no confusion in operation between the rotary control switch 29 and the high speed rotation instruction switch 28. The operability of the handle 11 for controlling the angle and the swing of the rotary blade 14 is not lowered, because the high speed rotation instruction switch 28 of rotary type is operated by the thumb of hand without reducing the gripping force applied to the cylindrical body 12a of the grip 12.

When the electric power switch 26 is operated so as to stop the flat motor 13, the rotation of the flat motor 13 due to the inertia thereof is prevented by the dynamic brake circuit 10b of the convertor 9, so that the injury by the rotation of the rotary blade 14 immediately after the stop of cutting is prevented, and the safety of cutting work is secured.

The present invention can be applied to the brush cutter of the type wherein the battery 9 is carried on the back.

It is also possible to have a current limiter or an overload stop circuit for stopping the flat motor 13 in case of overload. Further, it is possible to provide on the converter 10 an overdischarge preventing circuit for preventing the overdischarge of the battery 9.

While the invention has been particularly shown and described with reference to the preferred embodiments thereof, it will be understood by those skilled in the art that various changes in form and details may be made therein without departing from the spirit and scope of the invention as defined by the appended claims.

What is claimed is:

1. A brush cutter comprising a main pipe, a flat motor provided on a tip end of the main pipe, a rotary blade provided on a rotary shaft of the flat motor, and a battery provided on a base end of the main pipe for driving the motor.

2. The brush cutter as claimed in claim 1, wherein the flat motor comprises a housing for supporting rotatably the rotary shaft, a rotor fixed to the rotary shaft, a magnet provided on the rotor, a planar stator having a wiring of electric circuit fixed to the housing, a main pipe mount portion provided on the housing, and a holding portion for holding selectively the rotary cutter to the rotary shaft.

3. The brush cutter as claimed in claim 1, further comprising a handle having a grip provided with a power switch for starting and stopping the motor, and a control switch for controlling the revolution number of the motor, the handle being provided on the main pipe, and the control switch being arranged in the vicinity of the power switch.

4. The brush cutter as claimed in claim 3, wherein the control switch is of roller type to be operated by a forefinger of hand which grasps the grip.

5. The brush cutter as claimed in claim 4, further comprising a high speed rotation instruction switch for fixing the revolution number of the motor to a maximum value arranged in the vicinity of the power switch.

6. The brush cutter as claimed in claim 5, wherein the high speed rotation instruction switch is of rotary type operated by a thumb of hand which grasps the grip.

7. The brush cutter as claimed in claim 3, further comprising a high speed rotation instruction switch for fixing the revolution number of the motor to a maximum value arranged in the vicinity of the power switch.

8. The brush cutter as claimed in claim 7, wherein the high speed rotation instruction switch is of rotary type operated by a thumb of hand which grasps the grip.

9. The brush cutter as claimed in claim 7, further comprising a dynamic brake circuit connected to the power switch for breaking the rotation of the motor when the motor is stopped.

10. The brush cutter as claimed in claim 3, further comprising a dynamic brake circuit connected to the power switch for breaking the rotation of the motor when the motor is stopped.

11. The brush cutter as claimed in claim 3, wherein the power of the flat motor is about 250 W-800 W.

12. The brush cutter as claimed in claim 2, further comprising a handle having a grip provided with a power switch for starting and stopping the motor, and a control switch for controlling the revolution number of the motor, the handle being provided on the main pipe, and the control switch being arranged in the vicinity of the power switch.
